(19) United States
(12) Patent Application Publication
(10) Pub. No.: US 2008/0181591 A1
(43) Pub. Date: Jul. 31, 2008

(54) CAMERA POSTURE ESTIMATION DEVICE, VEHICLE, AND CAMERA POSTURE ESTIMATION METHOD

(75) Inventor: Hitoshi HONGO, Shijonawate City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 12/018,334

(22) Filed: Jan. 23, 2008

(30) Foreign Application Priority Data
Jan. 26, 2007 (JP) JP2007-016258

(51) Int. Cl. G03B 17/00

(52) U.S. Cl. 396/50

(57) ABSTRACT

A camera posture estimation device includes: a generator configured to generate overhead view image data by transforming a viewpoint of captured image data obtained by the camera, on the basis of a posture parameter indicative of the posture of the camera; a calculator configured to calculate parallelism between lines in an overhead view image indicated by the overhead view image data generated by the generator; and a posture estimator configured to estimate the posture parameter from the parallelism calculated by the calculator.

### CROSS REFERENCE TO RELATED APPLICATIONS

This application is based upon and claims the benefit of priority from prior Japanese Patent Application No. 2007-016258, filed on Jan. 26, 2007; the entire contents of which are incorporated herein by reference.

### BACKGROUND OF THE INVENTION

1. Field of the Invention

The present invent relates to a camera posture estimation device, a vehicle and a camera posture estimation method.

2. Description of the Related Art

Conventionally, an image processor is known, which transforms image data from a camera provided on a vehicle into overhead view image data through the viewpoint transformation, and displays the obtained overhead view image for a user of the vehicle. As preconditions, such an image processor stores posture parameters indicative of posture conditions of the camera, and is disposed as the posture parameters indicate. On these preconditions, the image processor is configured to transform image data from the camera into overhead view image data on the basis of the posture parameters, and thereby to obtain an overhead view image looking as if viewed from directly above the vehicle. The image processor is required to satisfy it as a precondition that the camera should be disposed in exact accordance with the posture parameters. Accordingly, it is essential to dispose a camera in exact accordance with a posture indicated by posture parameters.

As a method for properly disposing a camera, one using a test pattern has been proposed. As for the configuration of this method, a test pattern serving as an indicator is first provided at a position away from a vehicle, and then the test pattern is captured with an on-vehicle camera. Thereafter, finally, on the basis of a condition of the captured image of the test pattern, it is examined whether or not the camera is disposed in exact accordance with a posture indicated by posture parameters (refer to Japanese Patent Publication No. 2001-91984, for example). In addition, another method has also been proposed in which a dedicated pattern is captured by a camera in a similar manner, so that posture parameters for a camera themselves are estimated (e.g., refer to R. Y. Tsai, “A versatile camera calibration technique for high-accuracy 3D machine vision metrology using off-the-shelf TV cameras and lenses,” Transaction on Pattern Analysis and Machine Intelligence 22(11), IEEE, 1987, pp. 323-344, and Z. Zhang, “A Flexible New Technique for Camera Calibration,” Journal of Robotics and Automation 3(4), IEEE, 2000, pp. 1330-1334).

Further, an image processor has also been proposed in which an attachment condition of a camera is adjusted with reference to parallel lines such as a white line drawn on the ground, and to infinity figured out from the parallel lines. Further, this processor includes an adjusting mechanism for adjusting a shooting direction of the camera. This mechanism is capable of adjusting the shooting direction even when the shooting direction is dislocated from the proper direction after the camera is attached (refer to Japanese Patent Publication No. 2000-142221). Similarly, an image processor has also been proposed in which posture parameters for a camera themselves are estimated with reference to parallel lines such as a white line drawn on the ground, and on infinity figured out from the parallel lines (refer to Japanese Patent Publication No. Heisei 7-77431, and Japanese Patent Publication No. Heisei 7-147000).

However, the image processor, in which a camera is disposed using a test pattern, requires that a test pattern or the like should be prepared in advance, and this produces problems of a cost, a storage place and an adjustment place for a test pattern or the like. Accordingly, it is far from easy to estimate a posture of the camera with such image processor.

Still further, by using the image processor in which a direction of a camera is adjusted with reference to the infinity, it is also far from easy to estimate the posture of a camera. Although, the infinity to be calculated on the basis of parallel lines is required for the estimation of the posture of the camera, it is not possible (or difficult) to obtain the infinity when a road on which the vehicle run is curved, or when there is an obstacle such as a vehicle, a building or the like ahead of the vehicle.

### SUMMARY OF THE INVENTION

A camera posture estimation device according to a first aspect of the present invention estimates a posture of a camera. The camera posture estimation device includes a generator, calculator, and posture estimator. The generator is configured to generate overhead view image data by transforming a viewpoint of captured image data obtained by the camera, on the basis of a posture parameter indicative of the posture of the camera. The calculator is configured to calculate parallelism between lines in an overhead view image indicated by the overhead view image data generated by the generator. The posture estimator is configured to estimate the posture parameter from the parallelism calculated by the calculator.

The camera posture estimation device according to the first aspect calculates parallelism between lines in the overhead view image, and estimates the posture parameter on the basis of the parallelism. Here, parallel lines drawn on a reference plane such as the ground are shown in parallel in the overhead view image. However, when the posture parameter is not adequately set, parallel lines actually drawn on the reference plane such as the ground are not shown in parallel in the overhead view image. Thus, by calculating the parallelism between lines in the overhead view image, the posture parameter can be obtained. Further, according to the first aspect, a test pattern or the like need not be prepared in advance since a posture parameter is obtained from the overhead view image, and difficulty in estimating a posture can be reduced since it is not necessary to calculate infinity. Accordingly, difficulty in estimating a posture of a camera can be reduced.

The camera posture estimation device according to the first aspect further includes an edge extractor configured to extract edges from the overhead view image data generated by the generator. The calculator determines the edges extracted by the edge extractor as lines in the overhead view image, and calculates the parallelism between the lines.

The camera posture estimation device according to the first aspect further includes a stationary state determiner configured to determine whether or not an object on which the camera is provided is stationary. When the stationary state determiner determines that the object is stationary, the calculator calculates parallelism between lines in the overhead view image.

The camera posture estimation device according to the first aspect further includes a start detector configured to detect a start of a mobile body on which the camera is provided. When the start detector detects that the mobile body starts moving, the calculator calculates the parallelism between lines in the overhead view image.

The camera posture estimation device according to the first aspect has a parameter changing mode. The parameter changing mode allows the posture parameter to be changed by an operation of a user.

The camera posture estimation device according to the first aspect further includes an informing unit configured to inform a user that the parallelism is within allowable range, in the case where the user changes the posture parameter through operation.

A vehicle according to a second aspect of the present invention includes a camera and a camera posture estimation device. The camera posture estimation device includes generator, calculator and posture estimator. The generator is configured to generate overhead view image data by transforming a viewpoint of captured image data obtained by the camera, on the basis of a posture parameter indicative of the posture of the camera. The calculator is configured to calculate parallelism between lines in an overhead view image indicated by the overhead view image data generated by the generator. The posture estimator is configured to estimate the posture parameter from the parallelism calculated by the calculator.

A camera posture estimation method according to a third aspect of the present invention is a method for estimating a posture of a camera. The camera posture estimation method includes a generation step, a calculation step and a posture estimation step. In the generation step, overhead view image data is generated by transforming a viewpoint of captured image data obtained by the camera, on the basis of a posture parameter indicative of the posture of the camera. In the calculation step, calculated is parallelism between lines in an overhead view image indicated by the overhead view image data generated in the generation step. In the posture estimation step, the posture parameter is estimated from the parallelism calculated in the calculation step.

### BRIEF DESCRIPTION OF THE DRAWINGS

FIG. 1 is a view showing a vehicle according to a first embodiment of the present invention.

FIG. 2 is a schematic block diagram of a vehicle surrounding image display system including the camera posture estimation device according to the first embodiment.

FIG. 3 is a flowchart showing a camera posture estimation method according to the first embodiment.

FIGS. 4A to 4D are diagrams showing how an edge extractor and a parallelism calculator shown in FIG. 2 perform processing. FIG. 4A shows a first example of an overhead view image; FIG. 4B shows histograms based on the overhead view image of FIG. 4A. FIG. 4C shows a second example of an overhead view image. FIG. 4D shows histograms based on the overhead view image of FIG. 4C.

FIG. 6 is a schematic block diagram of a vehicle surrounding image display system including a camera posture estimation device according to a second embodiment of the present invention.

FIG. 6 is a flowchart showing a camera posture estimation method according to the second embodiment.

FIGS. 7A to 7C show display examples of markers. FIG. 7A shows a first example. FIG. 7B shows a second example. FIG. 7C shows a third example.

### DETAILED DESCRIPTION OF THE PREFERRED EMBODIMENTS

### First Embodiment

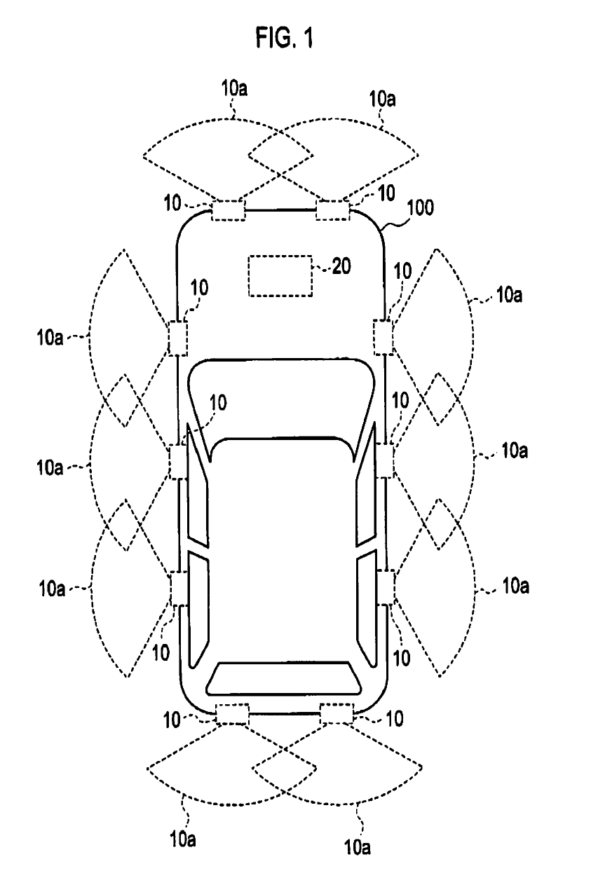

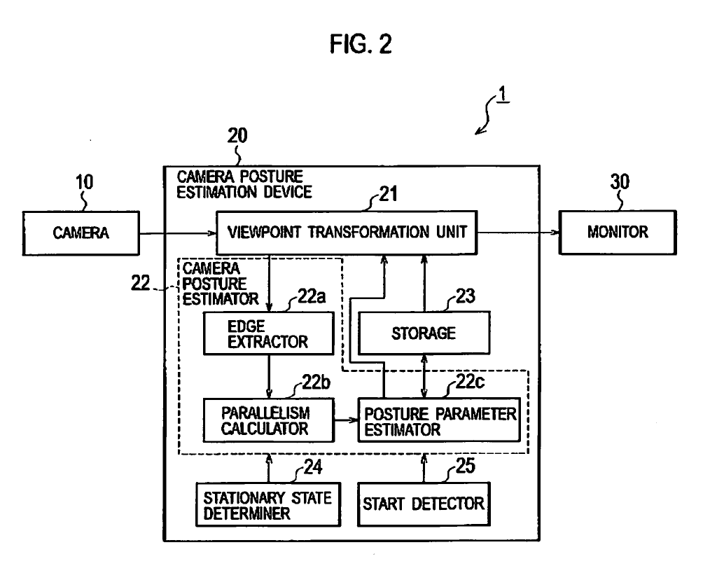

An embodiment of the present invention will be described with reference to the accompanying drawings. This embodiment will be described taking, as an example, a camera posture estimation device mounted on a vehicle. FIGS. 1 and 2 each show a schematic block diagram of a vehicle surrounding image display system including a camera posture estimation device of a first embodiment.

As shown in FIG. 1, a plurality of cameras 10 and a camera posture estimation device 20 are provided on a vehicle 100. The cameras 10 are provided on front parts, side parts, and rear parts of the vehicle 100. The cameras 10 provided on the front parts have imaging ranges 10a in a front direction of the vehicle 100. The cameras 10 provided on the side parts have imaging ranges 10a in side directions of the vehicle 100. The cameras 10 provided on the rear parts have imaging ranges 10a in a rear direction of the vehicle 100. However, positions of the cameras 10 may be arbitrarily changed, and the width and angle of each imaging range 10a may also be arbitrarily changed.

The camera posture estimation device 20 is provided on an engine control unit (ECU) or the like of the vehicle 100. However, a position of the camera posture estimation device 20 may be arbitrarily changed.

As shown in FIG. 2, a vehicle surrounding image display system 1 includes a camera 10, the camera posture estimation device 20, and a monitor 80.

The camera 10 is provided on the body of a vehicle to take images of regions around the vehicle. The camera posture estimation device 20 is configured to generate an overhead view image (except an image of a vehicle viewed obliquely from above) that is an image looking as if viewed from above the vehicle, on the basis of captured image data obtained by a camera. This camera posture estimation device 20 generates the overhead view image on the basis of a posture parameter set for the camera 10. Here, the posture parameter set is used as an indicator of a posture of the camera 10, and specifically consists of a yaw angle representing a rotation angle about a vertical axis, a roll angle representing a rotation angle about a traveling direction of the vehicle, a pitch angle representing a rotation angle about a direction along a horizontal plane and perpendicular to the traveling direction, and the like. The camera posture estimation device 20 generates the overhead view image with the ground (road surface) set as a reference plane. Accordingly, a white line or the like drawn on a road is displayed with little distortion and high accuracy just as if actually viewed from above the vehicle.

The monitor 30 is adapted to display the overhead view image generated by the camera posture estimation device 20. By viewpoint the monitor 30, a vehicle driver can check an image of a region around the vehicle viewed from above the vehicle and recognize the presence of an obstacle or the like near the vehicle.

The camera posture estimation device 20 includes a function for estimating the posture of the camera 10. Hereinafter, the camera posture estimation device 20 will be described in detail. As shown in FIG. 2, the camera posture estimation device 20 includes a viewpoint transformation unit (generator) 21, a camera posture estimator 22, a storage 23, a stationary state determiner 24, and a start detector 25.

The viewpoint transformation unit 21 is configured to transform the viewpoint of captured image data obtained by the camera 10 on the basis of a posture parameter set in order to generate the overhead view image. The posture parameter set is stored in the storage 23, and the viewpoint transformation unit 21 reads the posture parameter set from the storage 23 to generate the overhead view image. The viewpoint transformation unit 21 is connected to the monitor 30, and outputs the generated overhead view image data to the monitor 30 to cause the monitor 80 to display the overhead view image. In addition, the viewpoint transformation unit 21 is also connected to the camera posture estimator 22, and outputs the generated overhead view image data to the camera posture estimator 22.

The camera posture estimator 22 is configured to estimate a posture of the camera 10, and includes an edge extractor (edge extractor) 22a, a parallelism calculator (calculator) 22b, and a posture parameter estimator (posture estimator) 22c.

The edge extractor 22a is configured to perform edge detection on overhead view image data generated by the viewpoint transformation unit 21. The edge extractor 22a identifies lines in the overhead view image by this edge detection. The parallelism calculator 22b is configured to calculate parallelism between the lines in the overhead view image indicated by the overhead view image data generated by the viewpoint transformation unit 21. The lines used here in the overhead view image have been extracted by the edge extractor 22a. That is, the parallelism calculator 22b first determines edges extracted by the edge extractor 22a as lines on the overhead view image, and then calculates parallelism between the lines.

The posture parameter estimator 22c is configured to estimate a posture parameter set on the basis of the parallelism calculated by the parallelism calculator 22b. Here, parallel lines drawn on the reference plane such as the ground should be also shown in parallel in the overhead view image. However, when the posture parameter set is not adequately set, parallel lines actually drawn on the reference plane such as the ground are not shown in parallel in the overhead view image. Accordingly, on the basis of parallelism between lines in the overhead view image, the posture parameter estimator 22c calculates a posture parameter set so that the lines in the overhead view image can be in parallel.

The stationary state determiner 24 is configured to determine whether or not an object on which the camera 10 is provided is stationary In this embodiment, since the camera 10 is provided on the vehicle, the stationary state determiner 24 determines whether or not the vehicle is stationary. Specifically, the stationary state determiner 24 determines whether or not the vehicle is stationary, on the basis of a signal from a wheel speed sensor or the like.

The start detector 25 is configured to detect a start of a mobile body on which the camera 10 is provided. In this embodiment, since the camera posture estimation device 20 is provided on the vehicle, the start detector 26 determines whether or not the engine of the vehicle is started. Specifically, the start detector 25 determines whether or not the vehicle is started, on the basis of a signal from an engine speed sensor or the like.

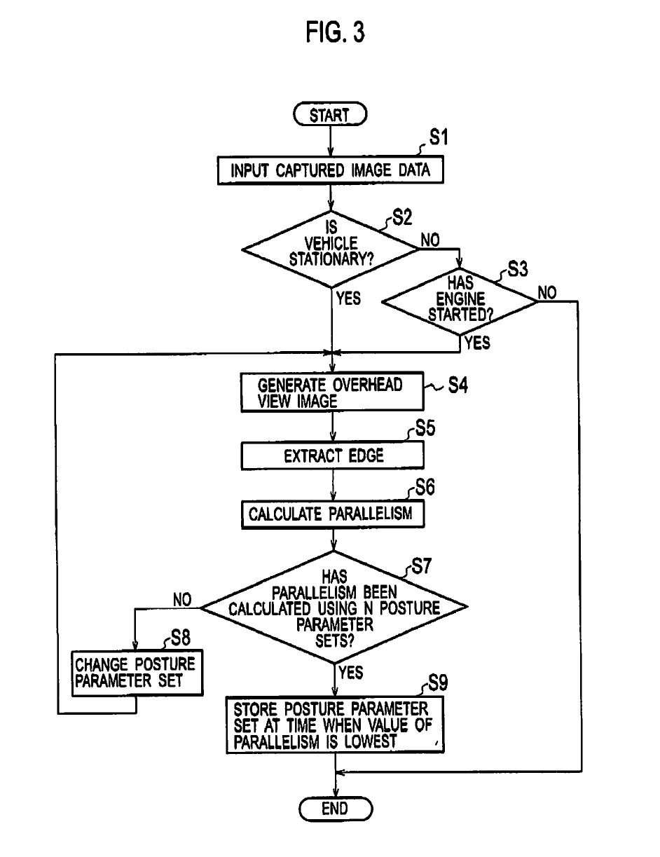

FIG. 3 is a flowchart showing a camera posture estimation method according to the first embodiment of the present invention. During normal operation, the camera posture estimation device 20 first receives captured image data from the camera 10, then generates an overhead view image, and finally outputs the overhead view image to the monitor 30. When estimating a posture parameter set, the camera posture estimation device 20 performs processing in the flowchart shown in FIG. 3.

As shown in FIG. 8, the camera posture estimation device 20 first receives captured image data (Step S1). Then, the stationary state determiner 24 determines whether or not the vehicle is stationary (Step 82). When it is determined that the vehicle is stationary (YES in Step S2), the processing proceeds to Step S4.

Meanwhile, when it is determined that the vehicle is not stationary (NO in Step S2), the start detector 25 determines whether or not the engine of the vehicle is started (Step S3). When it is determined that the engine is not started (NO in Step S3), the processing shown in FIG. 8 is terminated. When it is determined that the engine is started (YES in Step S3), the processing proceeds to Step S4.

In Step S4, the viewpoint transformation unit 21 performs viewpoint transformation on the basis of a posture parameter set stored in the storage 28 to generate an overhead view image (Step S4). The real space coordinate system is represented by an X-Y-Z coordinate system where; the Y-axis denotes a traveling direction of the vehicle: the Z-axis denotes the vertical direction; and the X-axis denotes a direction perpendicular to both the Y- and Z-axes. Further, rotations angles about the X-, Y- and Z-axes are respectively represented by (θ, φ, Ψ), and are measured clockwise. In addition, the coordinate system of the camera 10 is represented an X′-Y′-Z′ coordinate system where: the Y′-axis denotes a shooting direction of the camera 10; the X′-axis denotes a horizontal direction in the imaging surface of the camera; and the Z′-axis denotes a direction perpendicular to both the X′- and Y′-axes. The viewpoint transformation unit 21 performs coordinate transformation based on a transformation of Equation (1) below.

$$\begin{matrix}[ Equation 1 ] & \\ [ \begin{matrix}{X}^{′} \\ {Y}^{′} \\ {Z}^{′}\end{matrix} ] = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] [ \begin{matrix}X \\ Y \\ Z\end{matrix} ] & ( 1 )\end{matrix}$$

where

R₁₁=cos φ cos φ−sin θ sin φ sin φ

R₁₂=cos θ sin φ+sin θ sin φ cos φ

R₁₃=−cos θ sin φ

R₂₁=−cos θ sin φ

R₂₂=cos θ cos φ

R₂₃=sin θ

R₃₁=sin θ cos φ+sin θ cos φ sin φ

R₃₂=sin φ sin φ−sin θ s cos φ cos φ

R₃₃=cos θ cos φ

For the sake of simplicity of description, the roll angle φ and the yaw angle Ψ are set to 0°, the position of the camera 10 is set to (0, h, 0); and a focus position is set to f. When a point (X, Y, Z) is assumed to be projected onto a point p′ (x′, y′) on a captured image, Equation (2) below is established.

$$\begin{matrix}[ Equation 2 ] & \\ [ \begin{matrix}{x}^{′} \\ {y}^{′}\end{matrix} ] = [ \begin{matrix}\frac{{fX}^{′}}{h sin θ + {Z}^{′} cos θ} \\ \frac{f ( h cos θ - {Z}^{′} sin θ )}{h sin θ + {Z}^{′} cos θ}\end{matrix} ] & ( 2 )\end{matrix}$$

The viewpoint transformation unit 21 generates the overhead view image on the basis of Equations (1) and (2) described above. Further, a relationship between the camera coordinate system and the image coordinate system is expressed by Equation (3) below.

$$\begin{matrix}[ Equation 3 ] & \\ [ \begin{matrix}{x}^{′} \\ {y}^{′}\end{matrix} ] [ \begin{matrix}f \frac{{X}^{′}}{{Z}^{′}} \\ f \frac{{Y}^{′}}{{Z}^{′}}\end{matrix} ] & ( 3 )\end{matrix}$$

After generating the overhead view image, the edge extractor 22a performs an edge extraction on the overhead view image (Step S5). Thereby, edges of parallel lines such as white lines drawn on the ground are extracted. Then, the parallelism calculator 22b calculates parallelism between lines in the overhead view image, that is, the parallel lines or the like extracted by the edge extraction (Step S6).

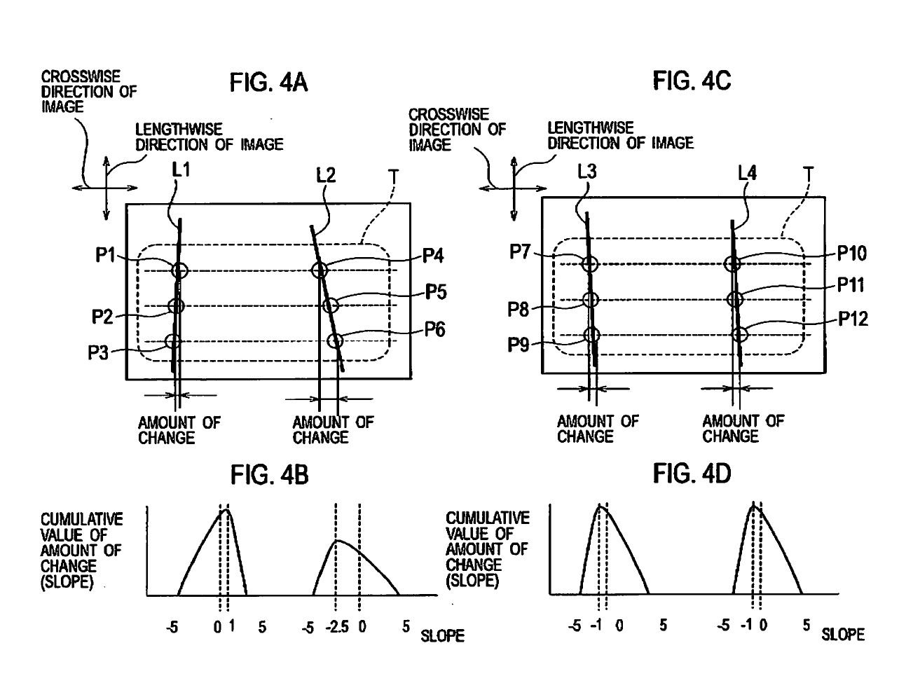

FIGS. 4A to 4D are diagrams showing how the edge extractor 22a and the parallelism calculator 22b shown in FIG. 2 perform processing. First, the edge extractor 22a performs edge detection in the lengthwise direction of the image (refer to FIGS. 4A and 4C. By this edge detection, lines L1 to L4 are retrieved as shown in FIGS. 4A and 4C. At this time, the edge extractor 22a uses Prewitt operator, a method for performing edge detection on an image by computing the first derivatives of its pixel values, for example. Then, the edge extractor 22a performs edge detection from the center to the left and right edges of the image (refer to FIGS. 4A and 4C), and preferentially extracts the first-detected edge. This makes it more likely to extract parallel lines close to the center of the image, that is, edges of a white line drawn on a road surface.

As described above, after performing edge extraction, the parallelism calculator 22b performs sampling on the extracted edges. Specifically, the parallelism calculator 22b sets a search region T in the overhead view image. Thereafter, the parallelism calculator 22b performs sampling on lines L1 and L2 within the search region T.

In performing sampling, the parallelism calculator 22b first identifies a point P1 located in the uppermost position on the line L1 within the search region in the image. The parallelism calculator 22b stores therein the coordinates of the point P1. Subsequently, the parallelism calculator 22b identifies a point P2 on the line L1 located below the point P1 by predetermined pixels in the image, and stores therein the coordinates of the point P2. In the same manner, the parallelism calculator 22b identifies a point P3 on the line L1 located below the point P2 by predetermined pixels in the image, and stores therein the coordinates of the point P3. Thereafter, the parallelism calculator 22b sequentially identifies points on the line L1 located below the point P3 in the same manner, and stores therein the coordinates thereof.

Subsequently, the parallelism calculator 22b calculates the slope of the line segment between the points P1 and P2, with the crosswise and lengthwise direction of the image set as the X- and Y-axes, respectively. For example, when the coordinate values of the points P1 and P2 are given by (x1, y1) and (x2, y2), respectively, the parallelism calculator 22b calculates (y2−y1)/(x2−x1) as the slope of the line segment between the points P1 and P2. Thereafter, the parallelism calculator 22b stores this value. Subsequently, the parallelism calculator 22b calculates the slopes of the other line segments between the identified points on the line L1, in the same manner.

Next, as described above, the parallelism calculator 22b also calculates slopes of line segments between points on the lines L2. The parallelism calculator 22b thereafter makes a histogram of the plurality of slopes thus obtained. FIG. 4B shows histograms obtained from the overhead view image of FIG. 4A. As shown in FIG. 4B, the histogram on the line L1 has a peak around where the slope is “1,” and the histogram on the line L2 has a peak around where the slope is “−2.5.” The parallelism calculator 22b calculates, as the parallelism, the absolute value of the difference between these peak values, i.e., “3.5.” Incidentally, the lower the value of the parallelism is, that is, the smaller the difference between the slopes of the two lines, the more parallel the two lines are.

Note that, although only three points such as P1 to P3 have been sampled on each line in the description of FIGS. 4A and 4C, the parallelism calculator 22b actually samples K points. The number K represents a sufficient number of points to correctly calculate the parallelism. Further, it is preferable that the camera posture estimator 22 set a minimum value of the number of points K in advance, and does not calculate the parallelism when K points cannot be sampled on a line. This makes it possible to increase the reliability of the parallelism.

Referring back to FIG. 3, after calculating the parallelism in the way described above, the camera posture estimator 22 updates the posture parameter set, for example, by incrementing or decrementing the values in the posture parameter set, or by adding/subtracting predetermined values to/from the values in the posture parameter set. Further, the camera posture estimator 22 determines whether or not the parallelism has been calculated based on N posture parameter sets (Step S7). The camera posture estimator 22 has calculated the parallelism based on one posture parameter set stored in the storage 23. Thus, the camera posture estimator 22 determines that the parallelism has not been calculated based on the N posture parameter sets (Step S8). At this time, the camera posture estimator 22 changes, for example, the pitch angle θ by 1 degree.

The camera posture estimation device 20 repeats the above-described processes S4 to S8. In the meantime, the overhead view image such as one shown in FIG. 4C is generated, and a histogram of slopes of line segments between sampling points P1 to P9 on a line L3 and a histogram of slopes of line segments between sampling points and P8 to P12 on a line L4 are generated so that histograms such as those shown in FIG. 4D are obtained. As shown in FIG. 4D, each of the histograms on the lines L3 and L4 have a peak around where the slope is “−1.” Accordingly the parallelism calculator 22b obtains “0”, being an absolute value of the difference between these peak values, as the parallelism.

Then, when the camera posture estimator 22 has calculated the parallelism based on the N posture parameter sets (YES in Step S7), the posture parameter estimator 22c estimates, to be a suitable posture parameter set, the posture parameter set where the lowest value of the parallelism is obtained, and causes the storage 23 to store the suitable posture parameter set (Step S9). The processing shown in FIGS. 4 is terminated. Thereafter, in the subsequent processing, the overhead view image is displayed on the monitor 30 on the basis of the optimized posture parameter set.

### (Advantages)

As described above, in the camera posture estimation device 20 and the camera posture estimation method according to the first embodiment, the parallelisms of lines in the overhead view image are obtained, and the posture parameter set is determined on the basis of the parallelisms. In this case, parallel lines drawn on a reference plane such as the ground are shown in parallel in the overhead view image. However, an inadequate posture parameter set causes parallel lines, actually drawn on the reference plane such as the ground, to look out of parallel in the overhead view image. Thus, by calculating the parallelisms of lines in the overhead view image, the posture parameter set can be obtained. Further, in this embodiment, a test pattern or the like need not be prepared in advance since a posture parameter set is obtained from the overhead view image, and difficulty in estimating a posture can be reduced since it is not necessary to calculate infinity. Accordingly, difficulty in estimating a posture of a camera can be reduced.

Further, according to the first embodiment, edge extraction is performed on overhead view image data, and the extracted edges are determined as lines L in the overhead view image, parallelism between the lines is calculated. Thus, the parallelism can be easily calculated by using a conventional image processing technique.

Further, according to the first embodiment, since the parallelism is calculated when an object having a camera provided thereon is not moving, the parallelism is obtained by use of a stable image captured by the camera 10 in a stable state. In particular, the camera 10 is installed on the vehicle in the present embodiment. Accordingly, when the vehicle stops moving, that is, the vehicle stops in response to a traffic light or the like, a white line and the like, thus parallel lines, are quite likely to be around the vehicle. Thus, under such a condition, the parallelism is calculated. Consequently, a suitable camera posture can be estimated.

Further, according to the first embodiment, since the parallelism is calculated when a start of a mobile body (a vehicle) on which the camera 10 is provided is detected, a posture parameter set can be calculated on the basis of a stable image captured by the camera 10 in a stable state, such as when the mobile body starts moving. Especially, when a user operates (drives) a mobile body (a vehicle), a posture parameter set for the camera 10 provided on the mobile body (vehicle) he/she is about to operate (drive) can be estimated so that the user can easily perform a proper operation (driving). In addition, since a suitable camera posture parameter set is obtained, the user can be almost always provided with a correct overhead view image.

Further, the vehicle according to the first embodiment includes a camera 10 provided on the body thereof, and a camera posture estimation device 20. Incidentally, a vehicle can sometimes tilt due to the weights of a passenger or a load therein. In such a case, the posture of the camera 10 relative to the ground changes. However, even then, a posture parameter set changing every moment can be estimated, since the camera posture estimation device 20 estimates the posture parameter set for the camera 10 on the vehicle.

### Second Embodiment

Next, a second embodiment of the present invention will be described. The camera posture estimation device 20 of this embodiment is similar to that of the first embodiment, but differs in its configuration and processing contents. Only differences from the first embodiment will be described below.

FIG. 5 is a schematic block diagram of a vehicle surrounding image display system including a camera posture estimation device according to the second embodiment. The camera posture estimation device 20 shown in FIG. 5 has a parameter changing mode in which a posture parameter set can be changed by an operation of a user. Specifically, the camera posture estimation device 20 according to this embodiment has an automatic correction mode and the above-described parameter changing mode. In the automatic correction mode, a posture parameter set is estimated, and stored in the storage 23 as described in the first embodiment.

A switch set 40 is configured to receive operations from the user, and includes a mode setting switch 41 and a posture parameter setting switch 42. The mode setting switch 41 is a switch with which the automatic correction mode and the parameter changing mode can be switched. By operating this mode setting switch 41, the user can selectively set the camera posture estimation device 20 to the automatic correction mode or to the parameter changing mode.

The posture parameter setting switch 42 is a switch with which posture parameters are changed. After setting the camera posture estimation device 20 to the parameter changing mode using the mode setting switch 41, the user operates posture parameter setting switch 42 to change the posture parameter set stored in the storage 23.

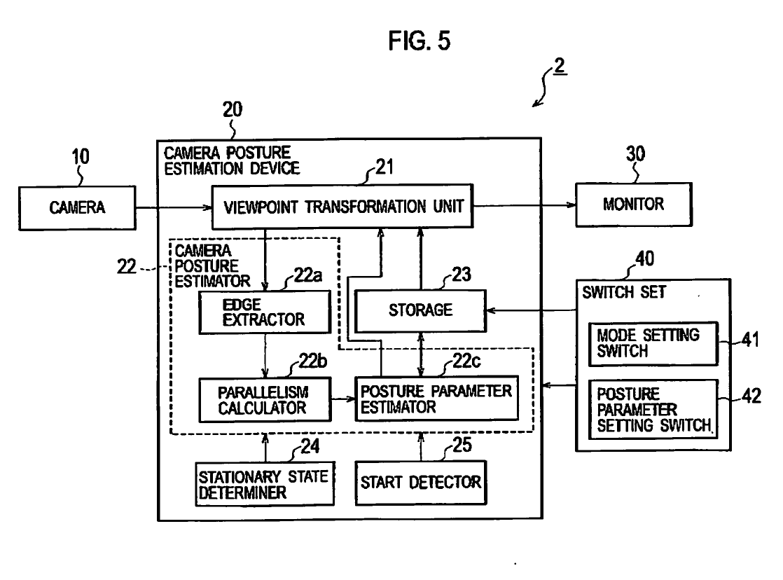

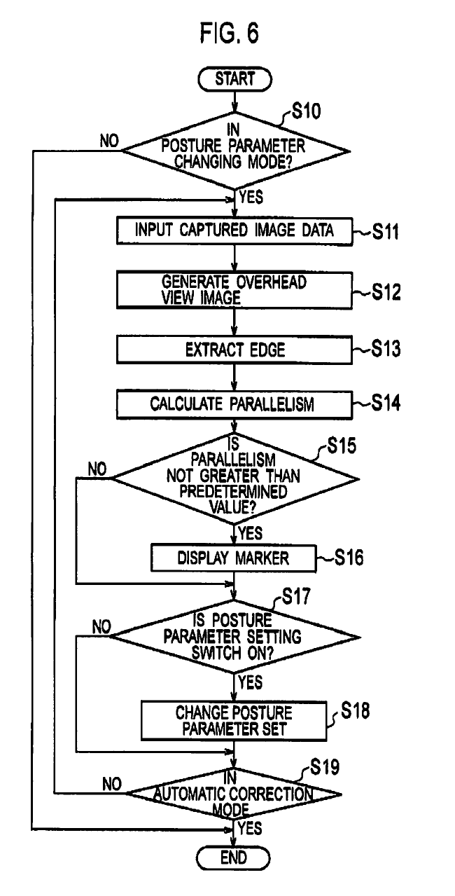

FIG. 6 is a flowchart showing a camera posture estimation method according to this second embodiment. First, the camera posture estimation device 20 determines whether or not it is set to the posture parameter changing mode (Step S10). When it is determined that the camera posture estimation device 20 is not set to the posture parameter changing mode (NO in Step S10), processing shown in FIG. 6 is terminated. Meanwhile, when “NO” in Step S10, the processing shown in FIG. 3 is performed.

On the other hand, when it is determined that the camera posture estimation device 20 has been set to the posture parameter changing mode (YES in Step S10), processes in Steps S11 to S14 are performed. These processes are the same as those in Step S1 and Steps S4 to S6.

Next, the posture parameter estimator 22c determines whether or not a calculated value of the parallelism is not greater than a predetermined value (Step S16). When the value of the parallelism is not greater than the predetermined value (YES in Step S15), the posture parameter set is accurate. Accordingly, the camera posture estimation device 20 causes the monitor 30 to display a marker indicating that the posture parameter set is accurate. Subsequently, the processing proceeds to Step S17.

When the value of the parallelism is greater than the predetermined value (NO in Step S15), the posture parameter set is not accurate. Accordingly, the camera posture estimation device 20 does not cause the monitor 30 to display the marker. Thereafter the processing proceeds to Step S17.

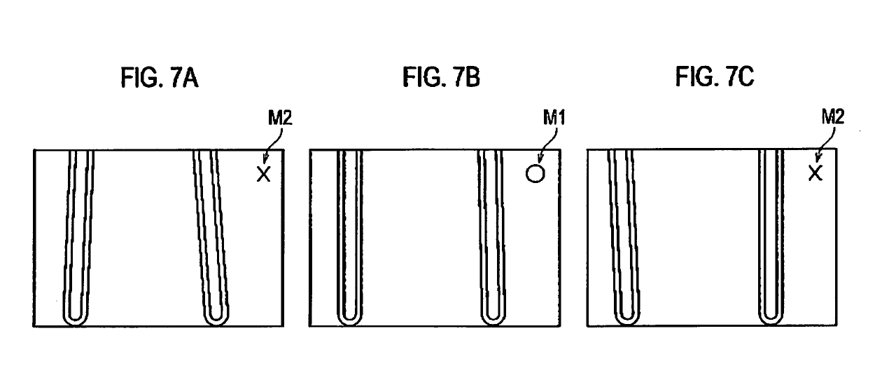

FIGS. 7A to 7C show display examples of markers. In the display examples shown in FIGS. 7A to 7C, markers are displayed on the basis of parallelism between parking frames. When the value of the parallelism is not greater than a predetermined value, the camera posture estimation device 20 causes the monitor 30 to display a marker M1 indicating that the posture parameter set is accurate, as shown in FIG. 7B. On the other hand, when the value of the parallelism is greater than the predetermined value, the camera posture estimation device 20 does not cause the monitor 30 to display the marker M1 as shown in FIGS. 7A and 7C. Incidentally, when the value of the parallelism is greater than the predetermined value, the camera posture estimation device 20 may cause the monitor 30 to display a marker M2 indicating that the posture parameter set is not accurate, as shown in FIGS. 7A and 7C.

Referring back to FIG. 6, in Step S17, the camera posture estimation device 20 determines whether or not the posture parameter setting switch 42 is pressed (Step S17). When it is determined that the posture parameter setting switch 42 is pressed (YES in Step S17), the camera posture estimation device 20 changes the posture parameter set (step S18), and thereafter the processing proceeds to Step S19. Meanwhile, when the posture parameter setting switch 42 is pressed, the pitch angle θ of the posture parameter set is increased by one degree. By continuing to press the posture parameter setting switch 42, the pitch angle θ reaches its maximum value. When the posture parameter setting switch 42 is pressed at this time when the pitch angle θ is at its maximum value, the pitch angle θ is set to its minimum value.

On the other hand, when it is determined that the posture parameter setting switch 42 is not pressed (NO in Step S17), the camera posture estimation device 20 does not change the posture parameter set, and the processing proceeds to Step S19.

In Step S19, the camera posture estimation device 20 determines whether it is set to the automatic correction mode (Step S19). When it is determined that the camera posture estimation device 20 is not set to the automatic correction mode (NO in Step S19), the processing proceeds to Step S11.

On the other hand, when it is determined that the camera posture estimation device 20 is set to the automatic correction mode (YES in Step S19), the processing shown in FIG. 6 is terminated. At the time when the processing shown in FIG. 6 is terminated, the posture parameter set changed by pressing the posture parameter setting switch 42 is stored in the storage 28.

### (Advantages)

In this manner, according to the camera posture estimation device 20 and the camera posture estimation method according to the second embodiment, difficulty in estimating the camera posture can be reduced as in the first embodiment. Further, the parallelism can be easily calculated by using a conventional image processing technique, and a suitable camera posture can be estimated. Accordingly, the user can be provided with a suitable overhead view to easily perform a proper operation (driving). In addition, a posture parameter set changing every moment can be almost always suitably estimated.

Further, according to the second embodiment, the user can change the posture parameter set. Accordingly, when the provided overhead view image does not satisfy the user or when something similar occurs, he/she can change the posture parameter set. Thus, the user can be provided with increased convenience.

Still farther, according to the second embodiment, the user does not have to determine himself/herself whether or not the posture parameter set is appropriately set. Accordingly, the user can be provided with increased convenience.

### Other Embodiment

Although the present invention has been described above on the basis of the embodiments, the present invention is not limited to the above-described embodiments, and variations may be made without departing from the spirit of the present invention.

For example, in the above-described embodiment, the edge extractor 22a performs edge detection from the center to the left and right ends of the image, and the first-detected edge is preferentially extracted. However, alternatively, weighing may be performed to use the weighted values in calculating the parallelism. Specifically, the edge extractor 22a divides the overhead view image into multiple regions, and performs weighting on the regions so that regions on which a white line or a road shoulder very likely exist are given priorities (for example, higher values are set in these regions). Further, such weighting may be performed on the regions so that regions closer to the center of the image are given priorities. Thereafter, once the slopes on one of hues L are obtained, it is determined which region contains the line L on which the slopes are obtained, and the slopes are multiplied by the value set in the above-described manner, i.e., the weight. Then, histograms of the weighted values of the slopes are generated. This method makes it possible to put smaller weights on objects that are quite unlikely to be parallel lines, other than a white line or a road shoulder. Consequently this method can check influences of cracks on the road or other edges which do not form parallel lines.

Further, in the first embodiment, the posture parameter estimator 22c calculates parallelism based on a plurality of posture parameter sets, and estimates, to be the most accurate posture parameter set, the posture parameter set where the lowest value of the parallelism is obtained. However, the way of estimation of the posture parameter set by the posture parameter estimator 22c is not limited to this. For example, the posture parameter estimator 22c may determine that the accuracy of a posture parameter set is low when the value of its corresponding parallelism is higher than a predetermined value, and that the accuracy of a posture parameter set is high when the value of its corresponding parallelism is not higher than the predetermined value.

In the second embodiment, the user is informed that the posture parameter set is accurate by means of the display of the marker M1. However the user may be informed that the posture parameter set is accurate by means of voice, audible alert, characters, or the like.

In the second embodiment, the posture parameter setting switch 42 and the monitor 30 are separately provided. However, alternatively, a touch panel may be built onto the monitor 30 so that the posture parameter setting switch 42 is displayed on the monitor 30 when the posture parameter changing mode is selected.

Further, in the second embodiment, the posture parameter set is changed by operating the posture parameter setting switch 42. However, alternatively the embodiment may be configured to receive the values of the posture parameter set that are directly inputted.

Further, in the first embodiment, the estimation of the camera posture parameter set is performed when a vehicle is stationary or starts traveling. However, the estimation does not have to be performed at this timing. The estimation may be constantly performed, or may be performed at predetermined intervals. In addition the estimation of the camera posture parameter set may be performed on the basis of the determination on whether or not the road is suitable for the estimation according to road information from a vehicle navigation system. Specifically, the camera posture parameter set will not be estimated on a curved road or a road winding up and down.

Still further, in the first and second embodiments, when road markings such as a pedestrian crosswalk, a speed limit sign, and a stop sign are drawn on a road, such road markings can possibly affect the estimation of the camera posture parameter set. Especially, when edges closer to the center of an image are given priorities as in the first embodiment, edges of a pedestrian crosswalk, a speed limit sign, and a stop sign will be extracted ahead of parallel Lines. Accordingly such road markings will affect the estimation of the camera posture parameter set more seriously. In order to address the problem, it is preferable that the edge extractor 22a detect not only lengthwise edges but also crosswise edges. When the rate of lengthwise edges is much higher than that of crosswise edges, it can he determined that a pedestrian crosswalk is drawn on the road. Accordingly, in such a case, the estimation of the camera posture parameter set is not executed to prevent an erroneous estimation.

What is claimed is:

1. A camera posture estimation device for estimating a posture of a camera, comprising:
a generator configured to generate overhead view image data by transforming a viewpoint of captured image data obtained by the camera, on the basis of a posture parameter indicative of the posture of the camera;
a calculator configured to calculate parallelism between lines in an overhead view image indicated by the overhead view image data generated by the generator; and
a posture estimator configured to estimate the posture parameter from the parallelism calculated by the calculator.

2. The camera posture estimation device according to claim 1, further comprising an edge extractor configured to extract edges from the overhead view image data generated by the generator, wherein
the calculator determines the edges extracted by the edge extractor as lines in the overhead view image, and calculates the parallelism between the lines.

3. The camera posture estimation device according to claim 1, further comprising a stationary state determiner configured to determine whether or not an object on which the camera is provided is stationary, wherein
the calculator calculates the parallelism between lines in the overhead view image, when the stationary state determiner determines that the object is stationary.

4. The camera posture estimation device according to claim 1, further comprising a start detector configured to detect a start of a mobile body on which the camera is provided, wherein
the calculator calculates the parallelism between lines in the overhead view image, when the start detector detects that the mobile body starts moving.

5. The camera posture estimation device according to claim 1, having a parameter changing mode allowing the posture parameter to be changed by an operation of a user.

6. The camera posture estimation device according to claim 1, further comprising an informing unit configured to inform a user that the parallelism is within allowable range, in the case where the user changes the posture parameter through operation.

7. A vehicle comprising a camera and a camera posture estimation device, wherein
the camera posture estimation device includes:
a generator configured to generate overhead view image data by transforming a viewpoint of captured image data obtained by the camera, on the basis of a posture parameter indicative of the posture of the camera;
a calculator configured to calculate parallelism between lines in an overhead view image indicated by the overhead view image data generated by the generator; and
a posture estimator configured to estimate the posture parameter from the parallelism calculated by the calculator.

8. A camera posture estimation method for estimating a posture of a camera, comprising the steps of:
generating overhead view image data by transforming a viewpoint of captured image data obtained by the camera, on the basis of a posture parameter indicative of the posture of the camera;
calculating parallelism between lines in an overhead view image indicated by the overhead view image data generated; and
estimating the posture parameter from the parallelism calculated.
